(19) United States
(12) Patent Application Publication
(10) Pub. No.: US 2004/0019668 A1
(43) Pub. Date: Jan. 29, 2004

(54) System and method for scalable management of computing devices

(76) Inventor: Deepak K. Kakadia, Union City, CA (US)

Correspondence Address: PARK, VAUGHAN & FLEMING LLP, 702 MARSHALL STREET, SUITE 310, REDWOOD CITY, CA, 94063, US

(21) Appl. No.: 10/202,710

(22) Filed: Jul. 24, 2002

(51) Int. Cl. G06F 15/173

(52) U.S. Cl. 709/223

(57) ABSTRACT

A system and methods for managing a large number of computing devices. A management station includes a talker for sending management commands and a listener for receiving command acknowledgements and/or responses. Commands are issued to multicast addresses, for delivery to multiple devices without having to originate multiple messages at the management station. Each command includes an identifier (e.g., sequence number) to distinguish it from other commands and allow the station to determine which commands a device has not acknowledged. A managed device acknowledges a command by transmitting the identifier to the management station. A device may acknowledge every command or may periodically or occasionally acknowledge the most recent command it received and/or applied. A managed device may not be continuously coupled to the management station (e.g., it may be offline or turned off). When reconnected, missed commands may be sent to the device (e.g., via unicast).

### BACKGROUND

This invention relates to the field of computer systems. More particularly, a system and methods are provided for managing large numbers of networked computing devices.

Management of networked computing devices has typically been performed one device at a time. That is, a management station establishes a unicast socket connection to a computing device to alter the device's configuration, set or read an attribute of a local object, etc. For each device requiring configuration or management activity, a separate connection or management session is established. Devices may be placed into a logical hierarchy to facilitate their management.

However, the number of computing devices within enterprise networks continues to increase and, in addition to the usual desktop and laptop computers, more and more handheld devices are being connected. Also, many devices are being coupled to networks via wireless or other relatively low-bandwidth communication links (e.g., dialup lines). For example, as PDAs (Personal Digital Assistants) and other small computing devices become more powerful and popular, more and more of them will be connected and require central management. Managing or configuring one device at a time becomes problematic when the number of devices to be managed becomes very large and diverse. For example, the use of a low-bandwidth link means that a management station's attention must be dedicated to a corresponding device even longer.

Yet further, some devices in a network may not be available (e.g., online) at all times. Thus, a PDA may be operated offline (e.g., disconnected from the network) or simply turned off. With current network management schemes, a management station may continually attempt to connect to an offline device to execute management activity, thereby consuming resources that could be used to manage other devices.

Thus, there is a need for a scalable system for managing network devices, and a method of managing a large number of devices, including devices having low-bandwidth connections and devices that may be offline at any given time.

### SUMMARY

In one embodiment of the invention, a system and methods are provided for facilitating the management of a large number of computing devices (e.g., hundreds, thousands). In this embodiment, a management station may issue a management command or request to multiple devices by send the command once, to a multicast address associated with all the devices.

In an embodiment of the invention, each management command includes an identifier (e.g., a sequence number) to distinguish it from other commands. A managed device may acknowledge a command by returning the identifier to the management station. Devices may acknowledge every command or may periodically or occasionally acknowledge the most recent command they received and/or applied.

A device may be coupled to the management station on a discontinuous or intermittent basis (e.g., the device may be turned off, or may be in use offline). Thus, the device may not receive all commands intended for the device. The management station may therefore track acknowledgements from devices by recording (e.g., for each device) which commands have or have not been acknowledged. A command that is not acknowledged by a device may be resent (e.g., via unicast) or superseded by a later command (e.g., via multicast).

In one embodiment of the invention, a management station includes a database for tracking acknowledgements and/or other data regarding managed devices, a talker process for issuing management commands, and a listener process for receiving acknowledgements and/or responses to commands. A managed device includes a management agent for receiving management messages containing commands, determining if they are for the local device and either executing the commands or passing them to another agent (e.g., an SNMP agent).

### DESCRIPTION OF THE FIGURES

FIG. 1 is a block diagram depicting an environment, including multiple computing devices, in which an embodiment of the present invention may be implemented.

FIG. 2 depicts a management station and a remotely managed network computing device, in accordance with an embodiment of the invention.

FIG. 3 is a flowchart demonstrating one method of managing computing devices, in accordance with an embodiment of the invention.

FIG. 4 demonstrates a scalable system for managing networked computing devices, according to one embodiment of the invention.

### DETAILED DESCRIPTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein.

The program environment in which a present embodiment of the invention is executed illustratively incorporates a general-purpose computer or a special purpose device such as a hand-held computer. Details of such devices (e.g., processor, memory, data storage, display) may be omitted for the sake of clarity.

It should also be understood that the techniques of the present invention may be implemented using a variety of technologies. For example, the methods described herein may be implemented in software executing on a computer system, or implemented in hardware utilizing either a combination of microprocessors or other specially designed application specific integrated circuits, programmable logic devices, or various combinations thereof. In particular, the methods described herein may be implemented by a series of computer-executable instructions residing on a suitable computer-readable medium. Suitable computer-readable media may include volatile (e.g., RAM) and/or non-volatile (e.g., ROM, disk) memory, carrier waves and transmission media (e.g., copper wire, coaxial cable, fiber optic media). Exemplary carrier waves may take the form of electrical, electromagnetic or optical signals conveying digital data streams along a local network, a publicly accessible network such as the Internet or some other communication link.

In one embodiment of the invention, a system and method are provided for managing computing devices. The devices may be of various types and may be coupled to a management station via various types of communication links. Some or all of the devices may be offline (e.g., not coupled to the management station) intermittently. However, when they reconnect, they can be updated with any management commands or activities that are required.

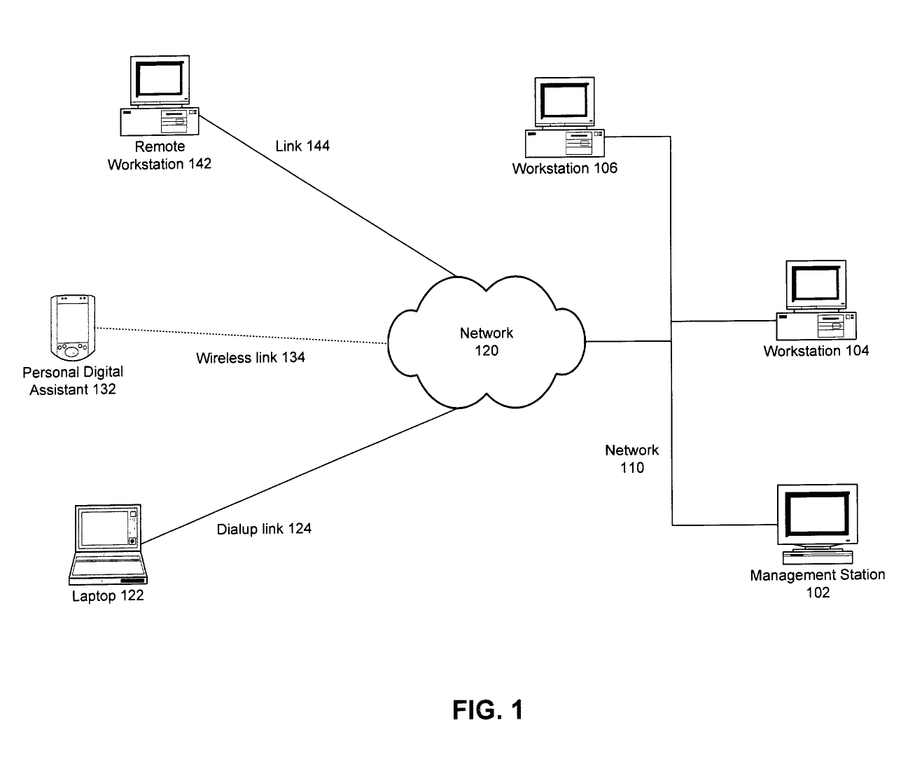

FIG. 1 depicts a computing environment in which an embodiment of the invention may be implemented. Within the illustrated environment, management station 102 is coupled to network 110, to which workstations 104, 106 are also connected. Network 110 may thus be a local organization or enterprise network.

Network 110 is coupled to network 120, which covers a larger geographical and/or logical area. Network 120 may comprise the Internet or other publicly available network.

Laptop or notebook computer 122 is coupled to network 120 (and management station 102) via dialup link 124, which may include various telephone company equipment. More particularly, laptop 122 may operate IP (Internet Protocol) over PPP (Point to Point Protocol) and access network 120 through a telephone company switch.

PDA (Personal Digital Assistant) 132 is a handheld computing device configured to communicate with network 120 through wireless link 134. PDA 132 may also operate IP over PPP, as well as CDMA (Code Division Multiple Access), GPRS (General Packet Radio Service), WAP (Wireless Access Protocol), UMTS (Universal Mobile Telecommunications System) or some other suitable protocol or system for communicating via a wireless link. PDA 132 may be coupled to network 120 continuously, discontinuously, intermittently or on some periodic basis. In particular, an operator of the PDA may connect to network 120 only periodically or occasionally (e.g., to exchange mail, synchronize files, make a telephone call).

Remote workstation 142 accesses network 120 through link 144, which may be a DSL (Digital Subscriber Line), cable or other high bandwidth channel. Thus, workstation 142 may operate IP over Ethernet, and link 144 may include a DSLAM (DSL Access Multiplexer) operating in conjunction with telephone company equipment, a cable modem, or other equipment.

Although not depicted in FIG. 1, the computing environment also includes routers, switches and/or other communication equipment for facilitating electronic communications. For example, in addition to communicating between endpoints via unicast packets or messages, the environment also supports the use of multicast and/or broadcast messages. As one skilled in the art will recognize, a network station or device may send a single message to a plurality of other devices associated with a particular multicast address or community. Intermediate communication equipment (e.g., routers, switches) will forward the message to the devices associated with that multicast address. Thus, the environment of FIG. 1 may support PIM (Protocol Independent Multicast) SM/DM (Sparse Mode/Dense Mode), DVRMP (Distance Vector Multicast Routing Protocol) and/or other multicast protocols or messaging schemes.

In the embodiment of FIG. 1, management station 102 is configured to manage some or all of the depicted devices via SNMP (Simple Network Management Protocol), CMIP (Common Management Information Protocol) or some other suitable management protocol. However, instead of having to manage each device individually or one at a time, the management station sends a single management command or request to multiple devices via a multicast message.

In particular, devices within the communication environment may be assigned to or associated with any number of multicast addresses or communities. Assignments may be made based on the type of a device, the type of communication interface of a device, a communication protocol used by a device, or any other characteristic of a device that may affect how it is managed or configured. For example, all devices of a particular type may be assigned to one address or community, and the management station can issue an appropriate command or request to all of the devices via a multicast transmission instead of sending it individually to each device.

In different embodiments of the invention, a management station and managed devices may operate according any present or future management protocol. Thus, in an embodiment of the invention configured for SNMP, a management station may issue a Get-Request (and one or more Get-Next operations, if necessary) to multiple devices to obtain information about one or more managed objects common to all devices. The management station may also issue a Set or Write command, via multicast, to set the value of an attribute of objects within the devices. Similarly, other SNMP operations such as Trap, Get-Bulk-Request, Inform-Request, Response, and so on, may be issued from one management station to another station and/or one or more managed devices, or from a managed device to a management station.

In another embodiment of the invention, SNMP may be augmented with JMX (Java Management Extension), by Sun Microsystems, Inc., to enhance network management operations through Java and/or various communication protocols such as HTTP (Hypertext Transport Protocol), HTTPS (Secure HTTP), IIOP (Internet Inter-Object Request Broker Protocol), etc.

Embodiments of the invention may be configured for implementation in environments having varying degrees of similarity to the environment of FIG. 1. In general, an embodiment of the invention may be applied in any environment in which a management station is electronically coupleable to one or more computing devices, regardless of the types of communication links (e.g., wired, wireless, point-to-point, network) and equipment (e.g., switches, routers, bridges, modem) through which they are coupled.

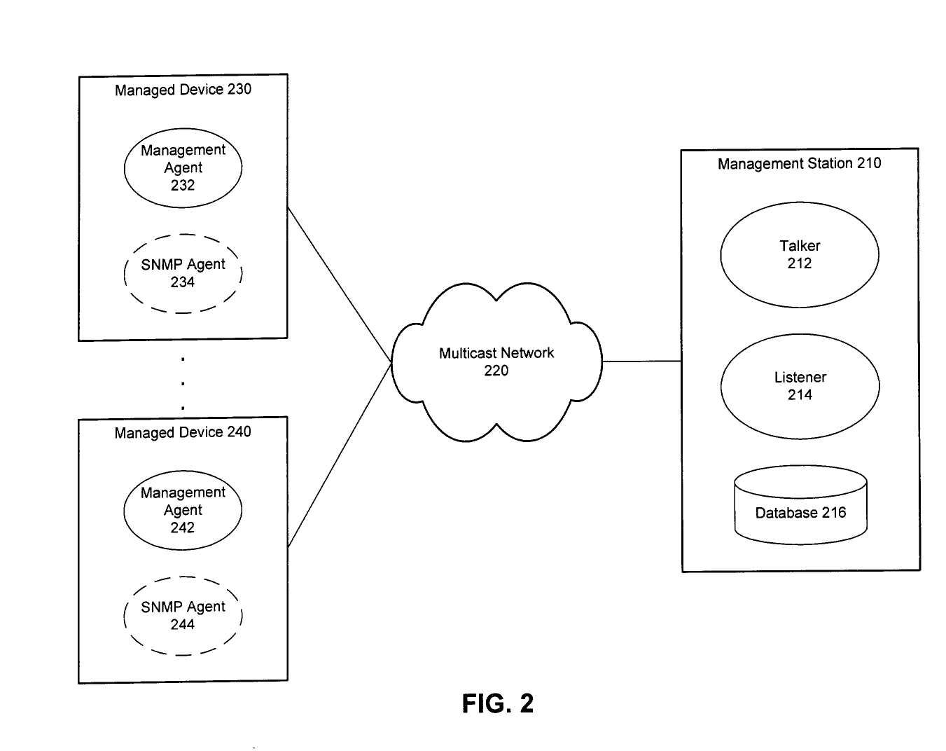

FIG. 2 is a block diagram of a management station and a plurality of managed computing devices coupled to the management station via a multicast network, according to one embodiment of the invention.

In FIG. 2, multicast network 220 comprises communication links (e.g., wired, wireless, fiber optic, copper) and equipment (e.g., routers, switches) that allow management station 210 to send management messages (e.g., commands, requests) to devices 230, 240 using one multicast address. The network may also support unicast messages.

Illustratively, one or more routers logically situated between the management station and the devices recognize one or more of the devices as being associated with a specified multicast address, and therefore forward the message to the device(s). Thus, rather than having to send one copy of the message for each managed device, one copy of the message can be issued and then automatically disseminated to multiple devices.

In an embodiment of the invention, management station 210 includes two processes—talker 212 and listener 214. The management station also includes a collection of data 216, which may comprise a database, a table or other data structure.

In this embodiment, talker 212 sends management commands and/or other messages to managed devices, including devices 230, 240. Talker 212 may select one or more multicast addresses for a particular command, based on the type of command and the devices that should receive it. As described above, devices may be associated with multiple multicast addresses based on various characteristics (e.g., their type, configuration, communication format, data rate).

Talker 212 may also be configured to transmit a management command to one or more specific managed devices. For example, if a particular device is offline or turned off when a management command is disseminated, it will not receive the command. When the device reconnects, talker 212 may send the command to the device via unicast. In an alternative embodiment of the invention, a separate process may be employed to send commands to individual devices.

Illustratively, each command sent by management station 210 to one or more devices includes an identifier (e.g., a sequence number) to distinguish that command from another. Database 216 or one of the processes of management station 210 records each management command that is issued. For example, database 216 may include a table or other listing identifying each managed device (e.g., by name, by address) and the sequence numbers of one or more management commands sent to the device (e.g., or to a multicast address associated with the device).

Listener 214 is configured to receive acknowledgements of management commands from devices 230, 240, and may also receive responses to commands (e.g., a value of a requested attribute). In one embodiment of the invention, a managed device acknowledges a command by transmitting to the management station the identifier (e.g., sequence number) of a command that it received and/or applied. Illustratively, each device may be configured to acknowledge every command it receives, or may periodically acknowledge the most recent command (e.g., every hour, every time it is coupled to network 220).

In the embodiment of FIG. 2, database 216 is updated whenever a device acknowledges a command. In particular, a record of commands sent to the device may be updated to reflect the acknowledgement. Therefore, the management station can simply refer to the database to determine if a particular device has acknowledged all commands or a particular command. The management station may also be configured to specifically query a device to determine if it has received or applied a particular command, or may use other information provided by the device.

For example, when a managed device is updated with new software, a periodic update sent from the device may include an acknowledgement (e.g., a command sequence number) that conflicts with a management station's database. In this situation, the management station may determine from the device's reported software version that it has been upgraded. The management station may then adjust its log or database for the device to reflect the new software version and the commands relevant to that version. Thus, managed devices and management stations can support different versions of management and protocol agent software.

In another embodiment of the invention, a device's management agent periodically sends to a management station an update regarding the last management command it executed. Illustratively, the management station (e.g., listener 214) may monitor specific channel configured to carry these updates.

In yet another embodiment of the invention, a managed device (e.g., a PDA, another handheld computing device) may automatically acknowledge, when it is coupled to network 220 after being off or offline, the most recent management command it received or applied.

When advised of a device's status (e.g., the last command it executed, management station 210 (e.g. listener 214) may determine, in response, which (if any) other management commands should be issued or reissued to the device. Talker 212 may then be instructed to issue those commands to the station.

Because some commands may supersede others, not all commands that a device missed may need to be sent. For example, some commands simply request information (e.g., a status or variable within the device), and may be repeated at a later time. Therefore, an early request for a particular attribute value may become irrelevant in light of a later request for the same value. Further, a management command that requires a response from a device (e.g., the value of an attribute of a local object), is inherently acknowledged if the device responds.

Also, not all commands are intended for all managed devices. Thus, when the management station identifies which commands a recently connected device has missed, it may also determine whether those commands are needed by the particular device. For example, if a missed command was directed to a multicast address or community that does not include the device, it need not be sent.

Referring again to FIG. 2, each managed device includes a management agent (e.g., 232, 242) and may also include a separate SNMP agent (e.g., 234, 244) or agent for some other management system or protocol. In one embodiment of the invention, a management agent includes functionality of an SNMP or other management protocol agent.

In particular, in one implementation of the embodiment of FIG. 2, management agents 232, 242 are configured to receive management messages (e.g., packets, cells, datagrams) and determine (e.g., based on their addresses) whether they are intended for their respective devices 230, 240. They are also configured, in this implementation, to extract the command and execute it (e.g., by setting or reading a particular variable or state within the device, updating or replacing a program on the device, transmitting information to the management station).

In one embodiment of the invention, a management agent (e.g., agent 232) may be downloaded to a device and installed as part of a Java virtual machine or as a separate application. In this embodiment, the agent is configured to execute a management command or pass it to another agent (e.g., SNMP agent 234) for execution. A management agent may also be configured to implement any desired security (e.g., through authentication, encrypting data sent to the management station, decrypting management messages).

Illustratively, a management agent may continually listen on one or more multicast addresses for a management message. When one arrives, it may spawn one or more separate threads or processes to parse the message, determine if it is addressed to the local device, authenticate the message, acknowledge the message, retrieve a command from the message, execute the command, etc.

Depending on the particular command received, the management agent may save a data file or a data value, update a local device variable or state, forward the command to a different agent (e.g., an SNMP agent), report a local variable or state to the management station, log and/or report an error, execute a program or script received with the message, etc. In particular, a management message may include a patch to, or a replacement for, the management agent.

Thus, in the illustrated embodiment of the invention, a management agent is configured to handle any management command that a management station may issue to a managed device, and respond if necessary.

In one embodiment of the invention, a management message from a management station to one or more managed devices may comprise any or all of the fields listed in TABLE 1.

TABLE 1

| Field | Description |
|---|---|
| Command Offset | Offset to command or program within message |
| Command | One or more management commands; or, a program to |
| | be executed |
| Data Offset | Of message includes a data file, location of file within |
| | message |
| Data | A data value or file |
| Destination(s) | One or more unicast or multicast addresses |
| Domain(s) | One or more multicast communities |
| Identifier | Identifier (e.g., sequence number) of command |
| Length | Length of message |
| Security | Public key, digital signature, etc. |
| Source | Address of management station |
| Version | Version of management software |

TABLE 2 lists various fields or pieces of information that may be reported by a managed device to a management station (e.g., in a periodic update) in an embodiment of the invention.

TABLE 2

| Field | Description |
|---|---|
| Ack | Sequence number of last management command |
| | successfully executed |
| Data | The last set of data sent in response to the management |
| | command indicated in the Ack field |
| Destination | Address of destination management station |
| Domain(s) | One or more multicast communities to which the |
| | managed device belongs |
| Length | Length of message |
| Security | Public key, digital signature, etc. |
| Version | Version of management software |

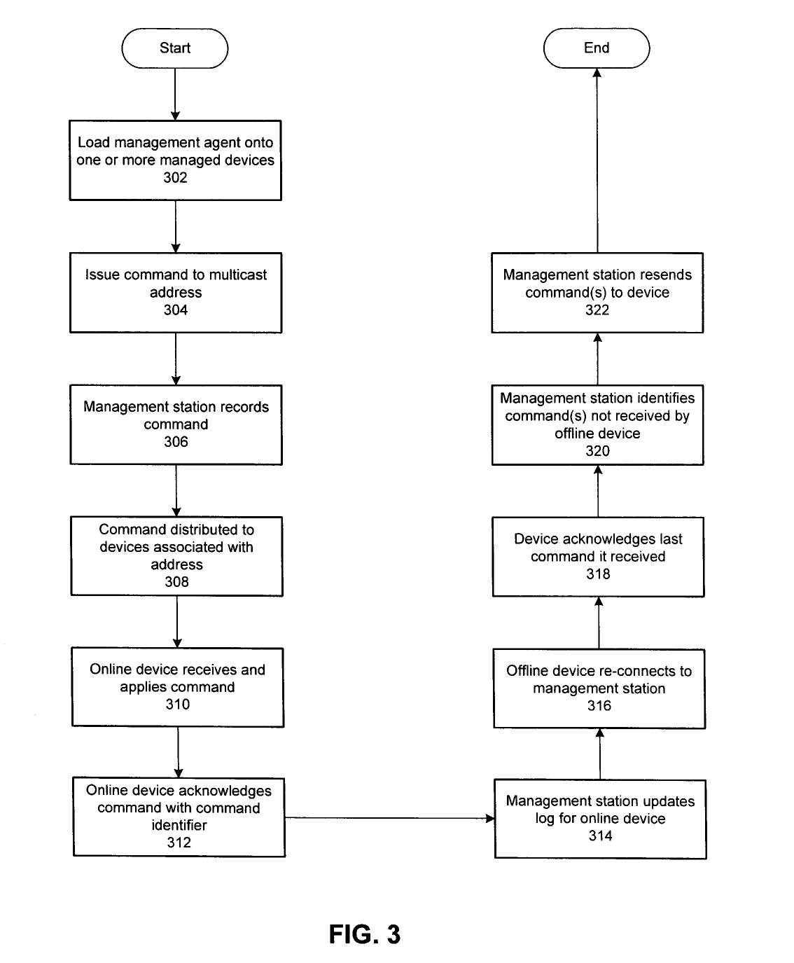

FIG. 3 demonstrates a method of managing computing devices via multicast, according to one embodiment of the invention.

In operation 302, a management agent is loaded onto one or more devices to be managed from one or more management stations. The management agent may include functionality for implementing a particular management protocol (e.g., SNMP), or a separate agent for the protocol may also be loaded. The management agent is configured to recognize one or more multicast addresses or communities as including the device and will therefore accept messages directed to those addresses.

In operation 304, a management station issues a management message to a multicast address associated with a set of managed devices. The message may instruct the devices to set or report a specified attribute of a local object, update or replace some local software (e.g., the management agent), execute a program included with the message, or take some other management action.

In operation 306, the management station records the command that was issued. For example, the station may record all commands sent to a particular device or a particular address, perhaps until it is acknowledged by each device.

In operation 308, the management message is distributed to all devices associated with the multicast address that are currently online. The distribution is automatically performed by routers, switches and/or other equipment located between the management station and the targeted devices. One or more of the targeted devices may be offline.

In operation 310, a first online device receives and executes the command. Illustratively, the local management agent recognizes that the message applies to the device, retrieves the command and implements it. This may entail reporting some information back to a management station.

In operation 312, the first online device acknowledges the management command, possibly as part of its report back to the station in operation 310. The device may be configured to acknowledge every command it receives and/or executes, or may report on a periodic basis the most recent command it received or executed. In this embodiment, the acknowledgement includes an identifier of the command that was received with the message.

When acknowledgement of one command is received, the management station may interpret the acknowledgement to cover multiple commands. Alternatively, one acknowledgement message from a device to a management station may identify multiple commands that were received or executed.

In operation 314, a management station receives the first online device's acknowledgement and updates its log or record accordingly.

In operation 316, a previously offline device is re-coupled or reconnected to the management station (or a network or communication link coupling the device and the station). Because the device was offline when the management message was delivered in operation 308, the device did not receive or execute the command.

In operation 318, the previously offline device acknowledges the most recent management command it received or executed.

In operation 320, the management station examines the acknowledgement and identifies any management commands the previously offline device has not acknowledged (including the command sent in operation 304). The station also determines which of the identified commands should be resent to the previously offline device. Some commands may no longer be relevant, or may have been superseded by later commands.

In operation 322, the management station sends one or more commands (in one or more messages) to the previously offline device. A retransmitted command may be sent via unicast or, if more than one device requires the same command, it may be sent via multicast. A device that already received and executed a command may be configured to ignore a duplicate of that command.

After operation 322, the method ends.

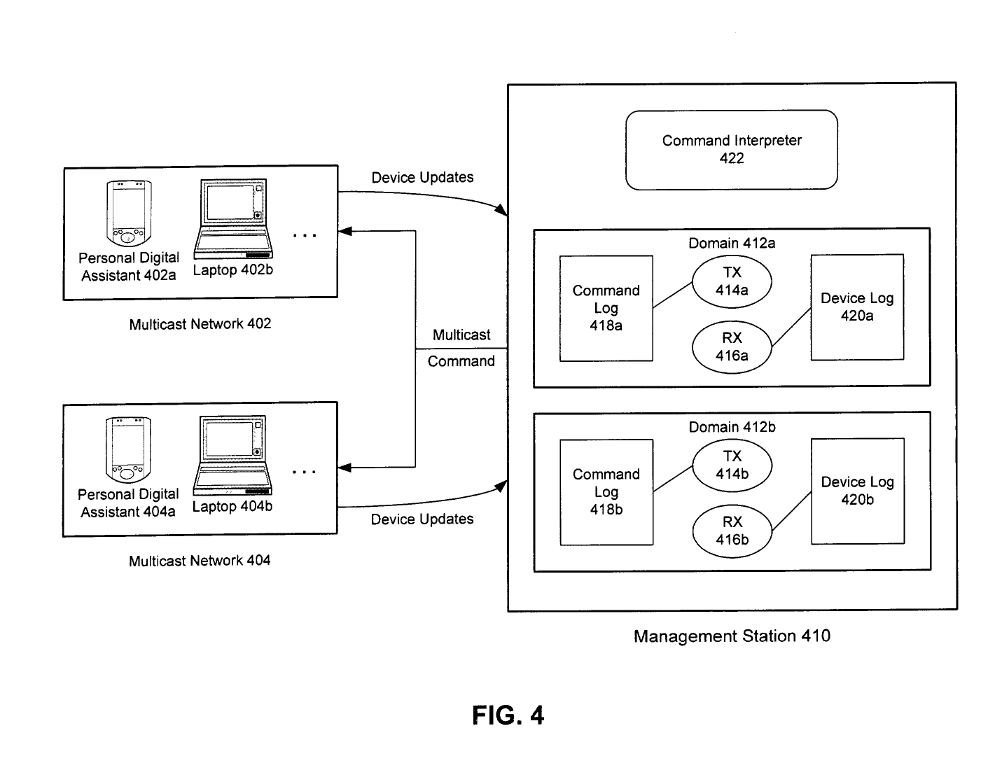

FIG. 4 demonstrates a scalable system for managing networked computing devices according to another embodiment of the invention. In this embodiment, every managed device subscribes to at least one multicast community or domain. Although only two domains are represented, the illustrated embodiment of the invention may be readily scaled for additional, and larger, domains.

In FIG. 4, management state 410 is configured to manage multicast networks 402, 404. Each network includes one or more computing devices (e.g., devices 402a, 402b within network 402). Illustratively, each multicast network is delineated along organization, enterprise, department, functional, security or other lines.

In this embodiment, for each multicast network, management station 410 includes a domain manager. Thus, domain 412a corresponds to multicast network 402 and domain 412b corresponds to multicast network 404. Management station 410 also includes command interpreter 422, which is configured to distribute management commands (e.g., from an administrator, from another management station) to domains 412a, 412b.

Each domain within the management station includes a transmitter or sender process (e.g., 414a, 414b) and a receiver or listener process (e.g., 416a, 416b). Each TX process maintains a command log (e.g., 418a) to record management commands issued to the domain, while each RX process maintains a device log (e.g., 420a) to record updates and/or acknowledgements from devices within the domain. In this embodiment, a command log includes a sequence number or identifier of each issued command and the command itself (e.g., “Discover,” “Set OID 1, 2,” “Get OID 4”). A device log includes a device's address or name and the latest command sequence number the device has acknowledged.

In an illustrative method of managing devices within the environment of FIG. 4, each device (e.g., devices 404a, 402b) is configured with a management agent and registered with a multicast-capable router (or other equipment) for its corresponding multicast addresses/communities/domains. For example, each device may register with a local router via IGMP (Internet Group Management Protocol).

When a network administrator or operator initiates a management operation that affects many devices, command interpreter 422 routes the operation to each affected domain. Each domain's TX process issues a multicast management instruction to its corresponding multicast network. Illustratively, the instruction may be sent as a UDP (User Datagram Protocol) packet. The TX process also records the issued command or instruction in its command log.

The log may be marked to indicate any commands that are dependent on or that supersede other commands. In one implementation of this embodiment, a command that has been made moot because of a later command may be removed from the log.

The management command is received at a management agent of each online device in the target network(s). The agent interprets the command as necessary and executes it or calls an agent that is configured to execute the command. Execution of the command may require the device to return some information to the management station (e.g., an object attribute).

When an offline device comes online, it issues a periodic update to management station 410 to inform the station of the last command it executed. Illustratively, if the offline device has never received a management command (e.g., it is new to the network), it sends a null. Online devices also send periodic updates of their last executed commands.

When an RX process (e.g., RX 416b) receives an update from a device (e.g., 404b), it records in its device log (e.g., 420b) the latest command sequence number acknowledged by the device. The RX process and/or TX process also uses the device log to determine which commands, if any, should be resent to the device. Any data or command reply included in the update are forwarded to the management application that originated the command.

The foregoing embodiments of the invention have been presented for purposes of illustration and description only. They are not intended to be exhaustive or to limit the invention to the forms disclosed. Accordingly, the scope of the invention is defined by the appended claims, not the preceding disclosure.

What is claimed is:

1. A method of managing multiple devices in a network from a management station, comprising:
downloading to multiple devices a management agent configured to accept management commands from the management station;
associating the multiple devices with a single multicast address;
sending a first management command to the multicast address; and
listening for acknowledgement of the first management command from each of the multiple devices.

2. The method of claim 1, further comprising:
receiving an acknowledgement of a previous management command from a first device of the multiple devices; and
resending said first management command to the first device.

3. The method of claim 1, further comprising:
for each of the multiple devices, tracking the most recent management command acknowledged by the device.

4. The method of claim 1, wherein the first management command comprises a sequence number for distinguishing the first management command from another management command.

5. The method of claim 1, wherein the acknowledgement comprises a sequence number of a management command.

6. The method of claim 1, wherein one or more of the multiple devices are discontinuously coupled to the management station.

7. The method of claim 1, wherein one or more of the multiple devices are handheld computing devices.

8. The method of claim 1, wherein the management agent comprises an SNMP (Simple Network Management Protocol) agent.

9. The method of claim 1, wherein the management agent is installed as part of a Java virtual machine on the multiple devices.

10. A computer readable storage medium storing instructions that, when executed by a computer, cause the computer to perform a method of managing multiple devices in a network from a management station, the method comprising:
downloading to multiple devices a management agent configured to accept management commands from the management station;
associating the multiple devices with a single multicast address;
sending a first management command to the multicast address; and
listening for acknowledgement of the first management command from each of the multiple devices.

11. A method of managing multiple computing devices within a network, comprising:
associating multiple computing devices within a network with a first multicast address, wherein one or more of the devices are coupled to the network on an intermittent basis;
issuing a first management command to the multicast address; and
at each of the multiple devices, acknowledging the most recent management command applied at the device.

12. The method of claim 11, further comprising:
for each of the multiple devices, tracking the most recent management command acknowledged by the device.

13. The method of claim 12, wherein the first management command is the most recently issued management command, the method further comprising:
receiving from a first device an acknowledgement of a previous management command; and
transmitting to the first device the first management command;
wherein the first device was not coupled to the network during said issuing.

14. The method of claim 11, wherein said acknowledging comprises:
transmitting an identifier of the most recent management command applied at the device.

15. The method of claim 11, wherein said acknowledging comprises:
coupling a first handheld computing device to the network, wherein the first handheld computing device was previously coupled to the network; and
transmitting an identifier of the most recent management command applied at the device during the previous time the first handheld computing device was coupled to the network.

16. The method of claim 11, further comprising:
downloading to a first computing device a management agent configured to receive management commands.

17. The method of claim 16, wherein the management agent comprises an SNMP (Simple Network Management Protocol) agent.

18. A computer readable storage medium storing instructions that, when executed by a computer, cause the computer to perform a method of managing multiple computing devices within a network, the method comprising:
associating multiple computing devices within a network with a first multicast address, wherein one or more of the devices are coupled to the network on an intermittent basis;
issuing a first management command to the multicast address; and
at each of the multiple devices, acknowledging the most recent management command applied at the device.

19. A method of managing computing devices, comprising:
installing a management agent in each of a plurality of computing devices, wherein each computing device is electronically coupleable to a management device;
associating the computing devices with one multicast network address;
issuing a first management command from the management device to the multicast address;
at each computing device, acknowledging a most recent management command received from the management device; and
at the management station, tracking acknowledgement of management commands by the computing devices.

20. The method of claim 19, wherein said installing comprises installing an SNMP (Simple Network Management Protocol) agent.

21. The method of claim 19, wherein said installing comprises installing a computer program configured to accept management commands from the management station.

22. The method of claim 19, wherein said first management command comprises a first identifier configured to distinguish the first management command from another management command.

23. The method of claim 22, wherein said acknowledging comprises transmitting from the device to the management station the first identifier.

24. The method of claim 19, wherein:
a first computing device is configured to be coupled to the management station on a discontinuous basis; and
for the first computing device, said acknowledging comprises:
establishing a connection with the management station; and
identifying to the management station the most recent management command applied at the first computing device.

25. The method of claim 19, wherein said tracking comprises:
for each computing device, recording the most recent management command acknowledged by the computing device.

26. The method of claim 25, further comprising:
receiving an acknowledgement, from a first computing device, of a management command other than the first management command.

27. The method of claim 26, further comprising:
determining whether one or more management commands, including the first management command, should be applied to the first computing device.

28. The method of claim 26, further comprising:
transmitting to the first computing device the first management command.

29. A computer readable storage medium storing instructions that, when executed by a computer, cause the computer to perform a method of managing computing devices, the method comprising:
installing a management agent in each of a plurality of computing devices, wherein each computing device is electronically coupleable to a management device;
associating the computing devices with one multicast network address;
issuing a first management command from the management device to the multicast address;
at each computing device, acknowledging a most recent management command received from the management device; and
at the management station, tracking acknowledgement of management commands by the computing devices.

30. A method of applying a management command at a centrally managed computing device, comprising:
receiving at the device a message transmitted to a multicast address from a management station;
extracting a management command from the message;
extracting an identifier of the management command from the message;
if the message comprises a set of data, extracting the data; and
executing the management command.

31. The method of claim 30, further comprising:
validating the message.

32. The method of claim 30, further comprising:
acknowledging the management command by transmitting the identifier to the management station.

33. The method of claim 30, further comprising prior to said receiving:
acknowledging a previous management command by transmitting an identifier of the previous management command to the management station.

34. The method of claim 30, wherein the command comprises a program.

35. The method of claim 30, wherein said executing comprises:
forwarding the command to an agent configured to execute the command.

36. The method of claim 30, wherein said executing comprises:
spawning a thread for executing the management command.

37. A computer readable storage medium storing instructions that, when executed by a computer, cause the computer to perform a method of applying a management command at a centrally managed computing device, the method comprising:
receiving at the device a message transmitted to a multicast address from a management station;
extracting a management command from the message;
extracting an identifier of the management command from the message;
if the message comprises a set of data, extracting the data; and
executing the management command.

38. An apparatus for managing multiple computing devices, comprising:
a listener process configured to receive, from each of multiple computing devices, an acknowledgement of a most recent management command received at the computing device;
a sender process configured to transmit, to a single multicast address, a first management command to be applied to the computing devices; and
a memory configured to store, for each computing device, said acknowledgement.

39. The apparatus of claim 38, wherein said first management command comprises a first identifier configured to distinguish the first management command from another management command.

40. The apparatus of claim 39, wherein said acknowledgement comprises the first identifier.

41. The apparatus of claim 38, wherein the sender process is further configured to transmit the first management command to a first computing device from which the listener process receives an acknowledgement of a management command previous to the first management command.

42. The apparatus of claim 38, further comprising:
a management agent configured to be downloaded to one or more of the computing devices.

43. The apparatus of claim 42, wherein the management agent comprises an SNMP (Simple Network Management Protocol) agent.

44. The apparatus of claim 38, wherein one or more of the computing devices are wireless devices.

45. The apparatus of claim 38, wherein one or more of the computing devices are personal digital assistants.

46. The apparatus of claim 38, wherein a first computing device is configured to be electronically coupled to the apparatus discontinuously.

47. The apparatus of claim 46, wherein the first computing device is configured to identify a most recently received management command each time the first computing device is coupled to the apparatus.
